(19) United States
(12) Patent Application Publication
(10) Pub. No.: US 2003/0151500 A1
(43) Pub. Date: Aug. 14, 2003

(54) Moving object tracking system

(75) Inventor: Takeshi Mitsui, Tokyo (JP)

Correspondence Address: SUGHRUE MION, PLLC, 2100 PENNSYLVANIA AVENUE, N.W., WASHINGTON, DC, 20037, US

(73) Assignee: MITSUBISHI DENKI KABUSHIKI KAISHA

(21) Appl. No.: 10/358,258

(22) Filed: Feb. 5, 2003

(30) Foreign Application Priority Data
Feb. 14, 2002 (JP) 2002-37224

(51) Int. Cl. B60R 25/10

(52) U.S. Cl. 340/426.1; 340/426.22; 340/988

(57) ABSTRACT

In a moving object tracking system, on-board equipment and equipment disposed in a management center are connected to each other by way of a communication network. The equipment disposed in the management center receives current position information about the current position of a moving object from the on-board equipment and keeps track of the moving object. The on-board equipment has a plurality of communication units for communicating with the equipment disposed in the management center in different manners, and a communication switching unit for selecting an optimum communication unit from among the plurality of communication units based on the current position information when detecting a theft of the moving object.

### BACKGROUND OF THE INVENTION

1. Field of the Invention

The present invention relates to a moving object tracking system that can ensure communications between on-board equipment disposed in a moving object and equipment disposed in a management center in order to automatically, surely inform the equipment disposed in the management center of current position information about the current position of the moving object, such as a car or a motorcycle, when the moving object is stolen or when necessary, and that can allow the equipment disposed in the management center to keep track of the moving object based on information sent from the moving object.

2. Description of Related Art

FIG. 7 is a block diagram showing the structure of a prior art moving object tracking system as shown in, for example, Japanese patent application publication (TOKKAI) No. 2000-182194. An operation of the prior art moving object tracking system for keeping track of a moving object will be explained hereafter, assuming that the moving object is a vehicle. In the figure, reference numeral 101 denotes on-board equipment, reference numeral 102 denotes equipment disposed in a management center, and reference numeral 103 denotes a communication network, such as the Internet, that connects between the on-board equipment 101 and the other equipment 102 disposed in the management center.

The on-board equipment 101 is provided with a vehicle position determination unit 112 for determining the current position of the vehicle based on signals received by way of a GPS antenna 111, a control unit 114 for detecting a theft of the vehicle and a position where the vehicle has been stolen based on a vehicle position determination signal from the vehicle position determination unit 112 and a detection signal from a moving object status detection unit 113 disposed outside the on-board equipment 101, an information storage unit 115 for storing detection information from the control unit 114, and a communication unit 116 for transmitting information about the theft of the vehicle and the position where the vehicle has been stolen, which is delivered from the control unit 114, to the other equipment 102 disposed in the management center by way of the communication network 103. The communication unit 116 has a transmit/receive antenna 117.

On the other hand, the equipment 102 disposed in the management center is provided with a communication unit 122 for receiving information sent, by way of the communication network 103, from the on-board equipment 101 through an antenna 121, a control unit 123 for determining whether or not the vehicle has been stolen and for identifying the position where the vehicle has been stolen, based on the information received by communication unit 122, a display unit 124 for displaying a screen corresponding to determination information obtained by the control unit 123, an operation unit 125 for inputting and delivering necessary information to the control unit 123, and an information storage unit 126 for storing the determination information obtained by the control unit 123.

Next, a description will be made as to an operation of the prior art moving object tracking system. The on-board equipment 101 detects the current position of the vehicle by using the vehicle position determination unit 112 based on GPS signals received by way of the GPS antenna 111. The on-board equipment 101 then determines whether or not the vehicle has been stolen and a theft position where the vehicle has been stolen based on the detected vehicle position and a detection signal from the moving object status detection unit 113 disposed outside the on-board equipment 101. The on-board equipment 101 stores information indicating the theft of the vehicle and the theft position in the information storage unit 115, and transmits the information, by way of the communication network 103, to the equipment 102 disposed in the management center by using the communication unit 116 and the antenna 117.

The equipment 102 disposed in the management center sends the information received by way of the antenna 121 to the control unit 123 by using the communication unit 122, displays the received information on the display unit 124 so as to keep track of the moving object, and stores the received information in the information storage unit 126. Furthermore, the equipment 102 disposed in the management center can transmit necessary information to the on-board equipment 101 by way of the communication network 103 by using the communication unit 122 and the antenna 121.

A problem encountered with a prior art moving object tracking system constructed as mentioned above is that while the moving object tracking system can keep track of a vehicle located in a wide area because on-board equipment can transmit position information about the current position of the vehicle to equipment disposed in management center by using a communication network such as the Internet, the moving object tracking system cannot keep track of the vehicle in a situation that only one communication unit installed in the on-board equipment cannot communicate with the equipment disposed in the management center, whereas another communication unit can communicate with the equipment disposed in the management center in a different manner.

### SUMMARY OF THE INVENTION

The present invention is proposed to solve the above-mentioned problems, and it is therefore an object of the present invention to provide a moving object tracking system that can ensure communications between on-board equipment and equipment disposed in a management center in order to automatically, surely inform the equipment disposed in the management center of current position information about the current position of a moving object, such as a car or a motorcycle, and that can allow the equipment disposed in the management center to keep track of the moving object based on information sent from the moving object.

In accordance with an aspect of the present invention, there is provided a moving object tracking system in which an on-board equipment has a plurality of communication unit for communicating with equipment disposed in a management center in different manners, and a communication switching unit for selecting an optimum communication unit from among said plurality of communication unit based on information about the current position of a moving object when detecting a theft of said moving object.

As a result, the moving object tracking system makes it possible to keep track of vehicles located in a wide area and to make notifications about them by using an optimum communication unit that is disposed independently of other communication units even when some of them have an electric field strength of 0.

Further objects and advantages of the present invention will be apparent from the following description of the preferred embodiments of the invention as illustrated in the accompanying drawings.

### BRIEF DESCRIPTION OF THE DRAWINGS

FIG. 1 is a block diagram showing the structure of a vehicle tracking system according to embodiment 1 of the present invention;

FIG. 2 is a block diagram showing the structure of an on-board equipment;

FIG. 3 is a flow chart explaining an operation of the vehicle tracking system according to embodiment 1 of the present invention;

FIG. 4 is an information table stored in an information storage unit and showing information about a plurality of communication units for a certain point A;

FIG. 5 is an information table stored in the information storage unit and showing information about the plurality of communication units for a certain point B;

FIG. 6 is a flow chart explaining an operation of a vehicle tracking system according to embodiment 2 of the present invention; and

FIG. 7 is a block diagram showing the structure of a prior art vehicle tracking system.

### DETAILED DESCRIPTION OF THE PREFERRED EMBODIMENTS

The invention will now be described with reference to the accompanying drawings.

Embodiment 1.

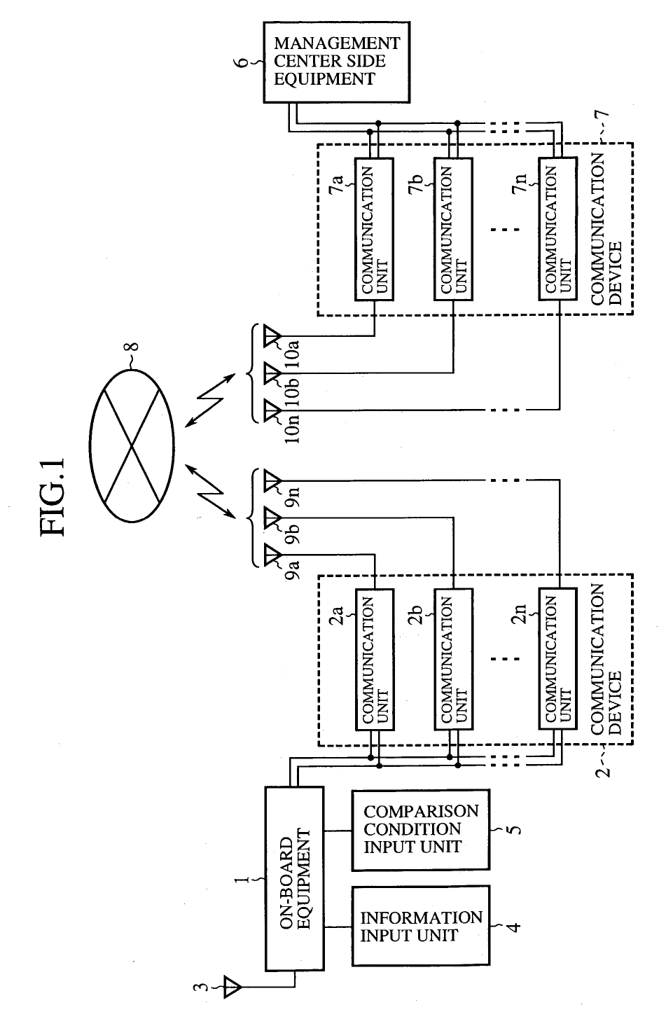

FIG. 1 is a block diagram showing the structure of a vehicle tracking system according to embodiment 1 of the present invention, for, when a vehicle equipped with on-board equipment is stolen or when necessary, enabling tracking of the vehicle by allowing the on-board equipment to inform equipment disposed in a management center (referred to as management center side equipment from here on) of necessary information. In the figure, reference numeral 1 denotes the on-board equipment, reference numeral 2 denotes a communication device provided with a plurality of communication units 2a to 2n that carry out communications in different manners, reference numeral 3 denotes a GPS antenna, reference numeral 4 denotes an information input unit for inputting information, such as charge for communications in a coverage, charge for communications in each area, and so on, used for selecting one communication unit from among the plurality of communication units 2a to 2n, reference numeral 5 denotes a condition input unit for inputting a comparison condition, such as “Communication status takes priority over any other information used for selecting one communication unit from among the plurality of communication units 2a to 2n”, that is used when one communication unit is selected from among the plurality of communication units 2a to 2n, and reference numerals 9a to 9n denote respective transmit/receive antennas of the plural of communication units 2a to 2n.

Reference numeral 6 denotes the management center side equipment, reference numeral 7 denotes a communication device provided with a plurality of communication units 7a to 7n that carry out communications in different manners and that are connected to the management center side equipment 6, reference numeral 8 denotes a communication network, such as the Internet, for connecting between the on-board equipment 1 and the management center side equipment 6, and reference numerals 10a to 10n denote respective transmit/receive antennas of the plurality of communication units 7a to 7n.

In the example shown in the figure, the communication device 7 is provided with the plurality of communication units 7a to 7n. As an alternative, the communication device 7 can be provided with only one communication unit that can carry out communications in a number of different manners.

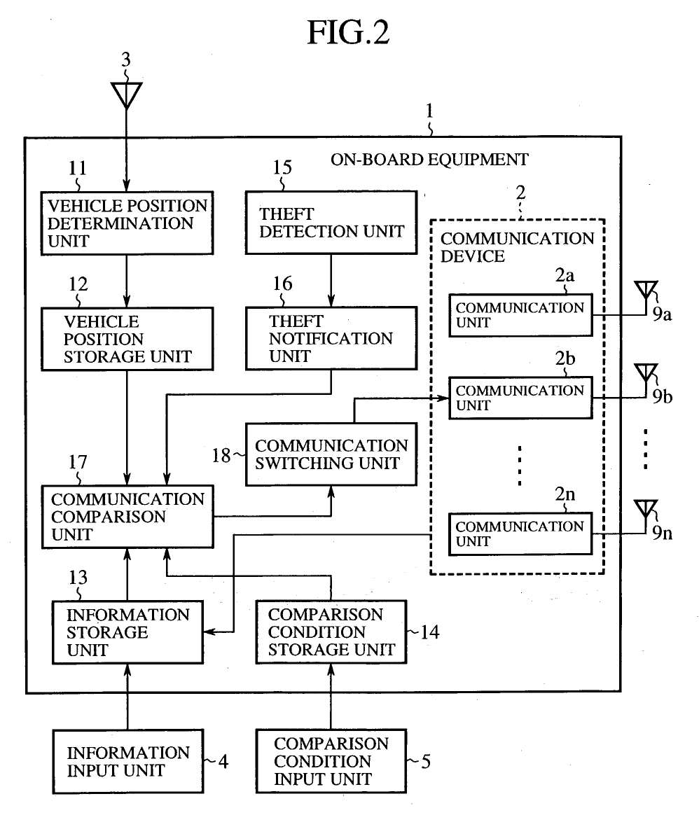

FIG. 2 is a block diagram showing the structure of the on-board equipment 1 in more detail. The on-board equipment 1 is provided with a vehicle position determination unit 11 for determining the current position of a vehicle equipped with the on-board equipment 1 based on GPS received signals received via the GPS antenna 3, a vehicle position storage unit 12 for storing the vehicle position delivered thereto and determined by the vehicle position determination unit 11, an information storage unit 13 for storing information used for selecting one communication unit from among the plurality of communication units 2a to 2n, which can be input by users by way of the information input unit 4, a condition storage unit 14 for storing a comparison condition input by the condition input unit 5, a theft detection unit 15 detecting a theft of the vehicle by determining whether or not the engine has been normally started or by detecting an impact that occurs when a door glass is broken, for example, a theft notification unit 16 for making a notification about theft information delivered thereto and obtained by the theft detection unit 15, a communication comparison unit 17 for comparing plural pieces of information read from the information storage unit 13 according to on the comparison condition read from the condition storage unit when receiving a vehicle position signal delivered from the vehicle position storage unit 12, and a communication switching unit 18 for selecting one communication unit from among the plurality of communication units 2a to 2n based on an output signal of the communication comparison unit 17.

The plurality of communication units 2a to 2n can cover a wider coverage by using a plurality of mobile phones having different carriers, a mobile phone that can comply with a plurality of manners, or a combination of a mobile phone and a radio communication system, such as a dedicated short range communications (DSRC) system or a wireless LAN. Each of the plurality of communication units 2a to 2n can be built in the communication device 2. Any communication equipment owned by the driver of the vehicle can be connected, as one of the plurality of communication units 2a to 2n, to the communication device 2.

The vehicle position determination unit 11 can acquire information about the current position of the vehicle by performing arithmetic processing on outputs of sensors, such as a bearing sensor and a travel distance sensor, while also acquiring information about the current position of the vehicle from radio equipment such as a Global Positioning System (GPS) and a DSRC system.

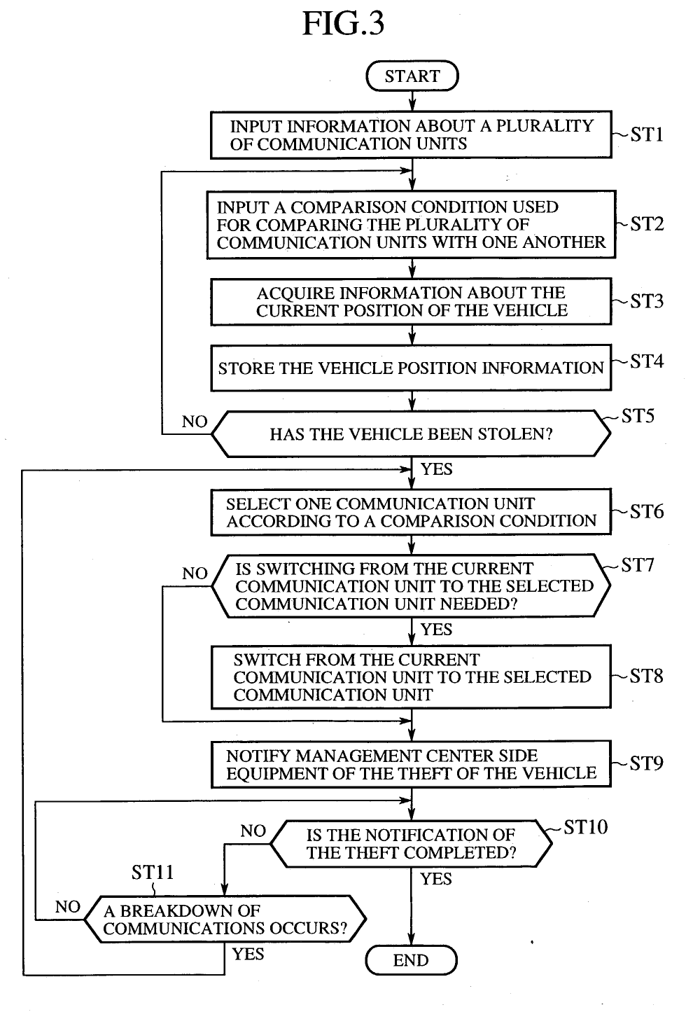

Next, a description will be made as to an operation of the moving object tracking system according to embodiment 1 of the present invention. FIG. 3 is a flow chart explaining the operation of the moving object tracking system according to embodiment 1 of the present invention. The moving object tracking system prestores information used for selecting one communication unit from the plurality of communication units 2a to 2n by using the information input unit 4 in the information storage unit 13. Furthermore, the moving object tracking system can store information about an electric field strength provided by each of the plurality of communication units 2a to 2n in the information storage unit 13. When a communication unit has its own battery, like mobile phones, and doesn't have a function of becoming charged by the moving object tracking system, the moving object tracking system can store battery information about the battery included in the communication unit in the information storage unit 13. The moving object tracking system stores a comparison condition, such as “Communication status takes priority over any other information used for selecting one communication unit from among the plurality of communication units 2a to 2n”, that is used when selecting one communication unit from among the plurality of communication units 2a to 2n, in the condition storage unit 14 by using the condition input unit 5. The input comparison condition can be changed when necessary. Either an optical disk, such as a CD-ROM, or a removable memory, such as a memory card, is used as each of the information storage unit 13 and the condition storage unit 14. In such manner as previously mentioned, the moving object tracking system inputs a plurality of pieces of information about the plurality of communication units 2a to 2n which can be used when communicating with the management center side equipment (in step ST1), and inputs a comparison condition used for comparing the plurality of pieces of information with one another (in step ST2).

The vehicle position determination unit 11 acquires information about the current position of the vehicle from radio equipment such as a Global Positioning Systems (GPS) or a DSRC system (in step ST3) and stores the position information in the vehicle position storage unit 12, such as a memory, at predetermined intervals (in step ST4). The moving object tracking system then determines whether or not the vehicle has been stolen by using the theft notification unit 16 (in step ST5). The communication comparison unit 17 compares the plurality of pieces of information about the plurality of communication units 2a to 2n, which are read from the information storage unit 13, with one another according to the comparison condition read from the condition storage unit 14, and selects an optimum communication unit from among the plurality of communication units 2a to 2n when determining that the vehicle has been stolen (in step ST6).

The communication comparison unit 17 further determines whether or not there is a need to switch from a current communication unit currently being used to the selected communication unit (in step ST7). If Yes in step ST17, the communication switching unit 18 switches from the current communication unit to the selected communication unit (in step ST8). On the other hand, if No in step ST7, the communication switching unit 18 keeps the selection of the communication unit currently being used so that the on-board equipment 1 uses it as before. The moving object tracking system then sends a notification about the theft of the vehicle and latest information about the current position of the vehicle determined by the vehicle position determination unit 11 to the management center side equipment 6 by way of the communication network 8 by using the communication unit selected in step ST6 (in step ST9.). The on-board equipment 1 determines whether or not the notification process of making a notification about the theft of the vehicle has been completed (in step ST10), and, if YES, stops the notification process.

On the other hand, if No in step ST10, the on-board equipment 1 determines whether an abnormal breakdown of communications occurs (in step ST11). Then, if Yes in step ST11, that is, when an abnormal breakdown of communications occurs before the notification process is completed normally, for example, when the vehicle moves during the notification about the theft of the vehicle and the electric field strength therefore changes, and this results in an abnormal breakdown of communications, the on-board equipment 1 returns to step ST6 in which it selects another communication unit that is second to the one previously selected in step ST6 according to the comparison condition in the above-mentioned way and retries the notification process. In contrast, if No in step ST11, the on-board equipment 1 returns to step ST10 in which it determines whether or not the notification process has been completed. During communicating with the management center side equipment by using a communication unit, such as a mobile phone, when the on-board equipment 1 detects a busy tone or the like because the party on the other end of the connection is busy or the communication line is busy, the on-board equipment 1 interrupts communication with the management center side equipment at once and starts communication with the management center side equipment by selecting an optimum communication unit that is second to the one previously selected in step ST6 according to the comparison condition and using the selected communication unit.

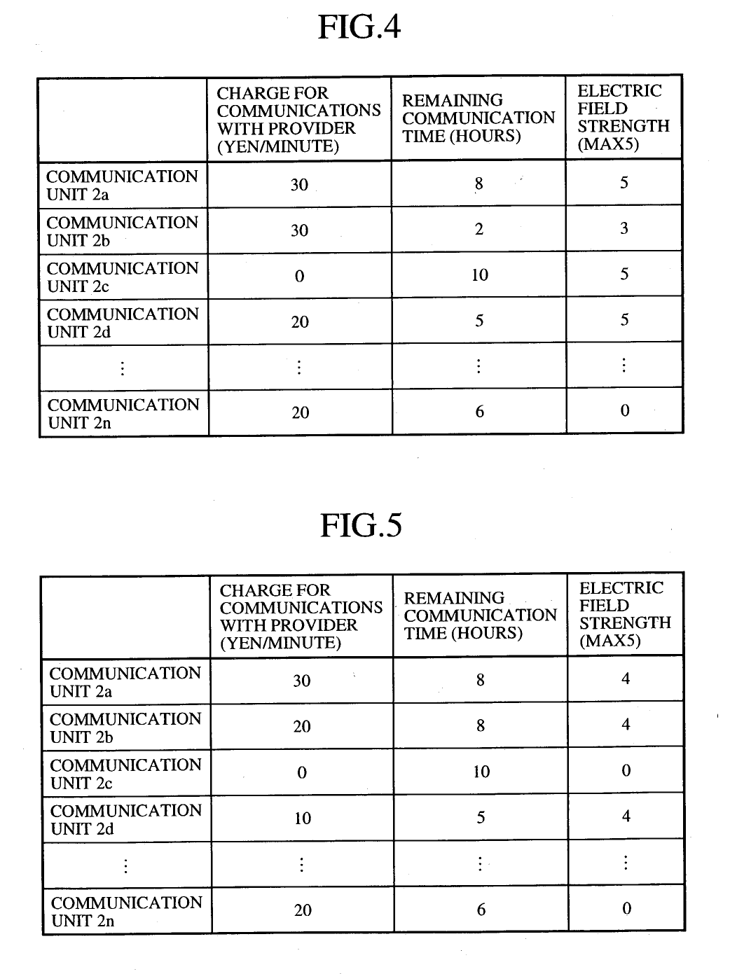

Next, an example of the process of switching among communication units will be explained. The information storage unit 13 stores a plurality of pieces of information about the plurality of communication units 2a to 2n, as shown in FIG. 4 (showing information about each communication unit for a certain point A) and FIG. 5 (showing information about each communication unit for a certain point B), for example. The condition storage unit 14 stores a comparison condition “Communication status takes priority over any other information used for selecting one communication unit from among the plurality of communication units 2a to 2n (i.e., comparison of a plurality pieces of information is carried out in order of “Electric field strength”, “Remaining communication time (hours)”, and “Charge for communications with provider (yen/minute)”.

In this case, the communication comparison unit 17 compares the communication statuses of the plurality of communication units 2a to 2n with one another (i.e., electric field strengths in the examples of FIGS. 4 and 5) according to the stored comparison condition in step ST6 of the flow chart: “selection of a communication unit according to the comparison condition”. For the point A of FIG. 4, the communication comparison unit 17 selects communication units 2a, 2c, 2d, and . . . each of which provides an electric field strength of “5”. Furthermore, the communication comparison unit 17 sequentially compares the remaining communication times (battery longevities) and charges for communications with provider of the selected communication units 2a, 2c, 2d, and . . . according to the comparison condition. The communication comparison unit 17 finally selects the third communication unit 2c having the longest remaining communication time of 10 hours and the lowest communication charge of 0 yens as an optimum communication unit. On the other hand, the communication comparison unit 17 selects the second communication unit 2b for the point B by comparing the plurality of pieces of information, as shown in FIG. 5, about the plurality of communication units 2a to 2n according to the same comparison condition.

When the comparison condition stored in the condition storage unit 14 is “Communication charge takes priority over any other information used for selecting one communication unit from among the plurality of communication units 2a to 2n (i.e., comparison of a plurality pieces of information is carried out in order of “Charge for communications with provider (yen/minute)”, “Electric field strength”, and “Remaining communication time (hours)”, the communication comparison unit 17, in step ST6 of the flow chart, selects an optimum communication unit by giving priority to comparison of communication charges during the comparison of the plurality of pieces of information about the plurality of communication units 2a to 2n, i.e., by comparing the plurality of pieces of information about the plurality of communication units 2a to 2n in order of “Charge for communications with provider (yen/minute)”, “Electric field strength”, and “Remaining communication time (hours)”. In this case, while for the point A of FIG. 4, the communication comparison unit 17 selects, as the optimum communication unit, the second communication unit 2c which is the same as the one selected when giving priority to comparison of communication statuses, for the point B of FIG. 4, the communication comparison unit 17 selects, as the optimum communication unit, the fourth communication unit 2d which is different from the one selected when giving priority to comparison of communication statuses. The on-board equipment 1 can thus enable switching among more various communication units by changing the comparison condition when necessary.

As mentioned above, in accordance with this embodiment 1, the on-board equipment can select an optimum communication unit by comparing a plurality of pieces of information about the plurality of communication units according to a comparison condition set by users, and can connect with the management center side equipment by using this selected communication unit by way of a communication network. As a result, the on-board equipment can surely transmit latest information about the current position of the vehicle to the management center side equipment.

Embodiment 2.

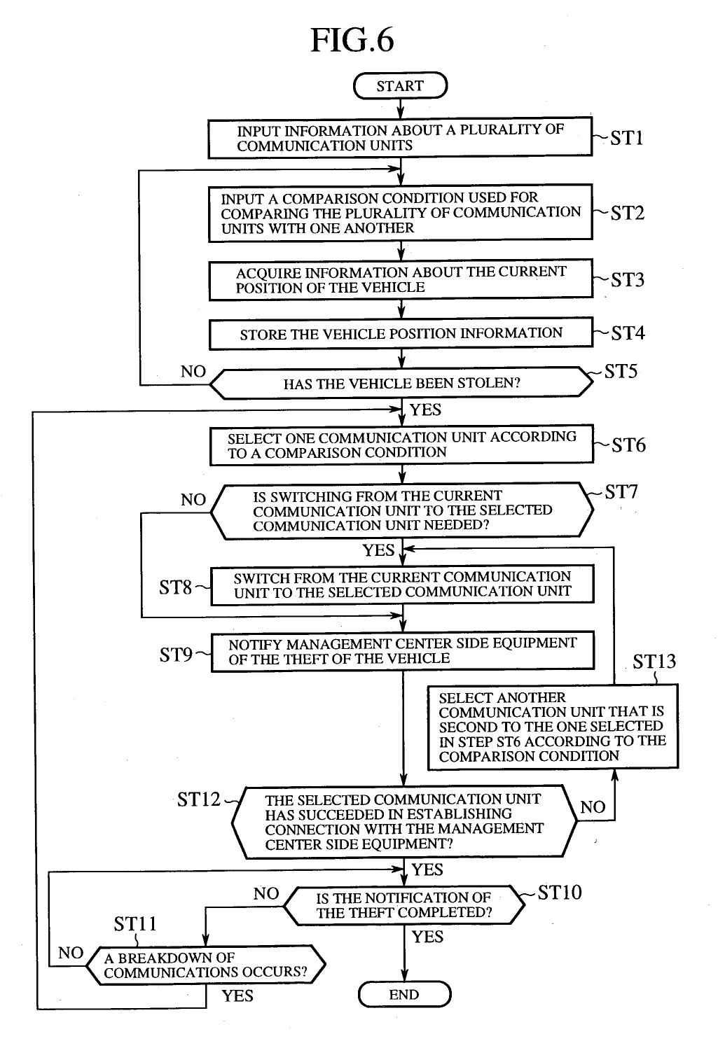

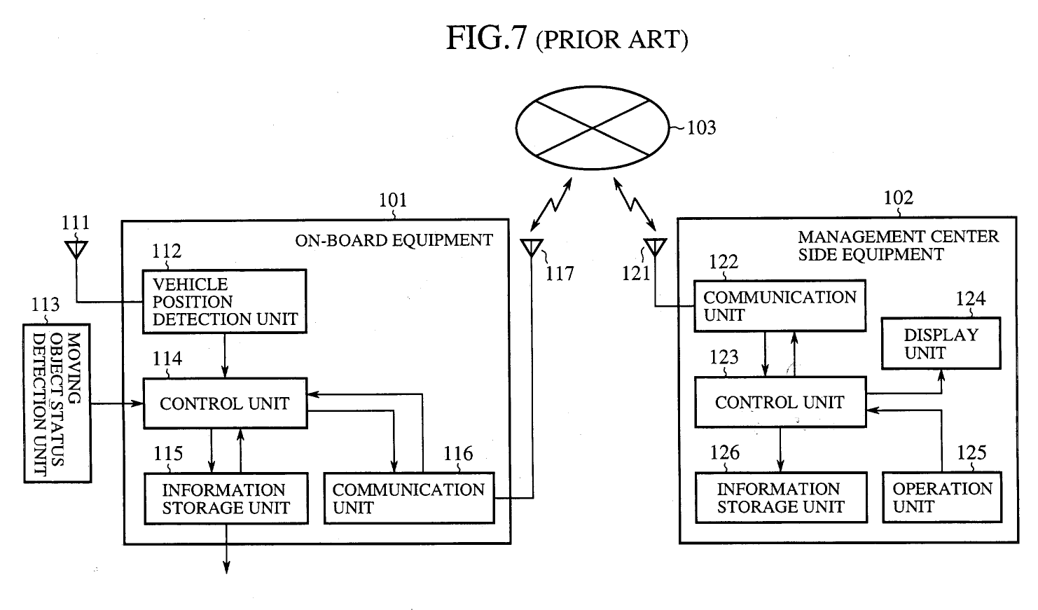

FIG. 6 is a flow chart explaining an operation of a moving object tracking system according to embodiment 2 of the present invention. In the figure, because steps ST1 to ST11 are the same as steps ST1 to ST11 of the flow chart of FIG. 3 explaining an operation of the moving object tracking system according to embodiment 1 of the present invention, the duplicated explanation will be omitted hereafter. As shown in FIG. 6, after on-board equipment 1 sends a notification about a theft of a vehicle equipped with the on-board equipment and latest information about the current position of the vehicle determined by a vehicle position determination unit 11 to management center side equipment 6 by way of a communication network 8 by using a selected communication unit (in step ST9), the on-board equipment 1 determines whether the selected communication unit has succeeded in establishing connection with the management center side equipment (in step ST12). If No in step ST12, the on-board equipment 1 selects another communication unit that is second to the one selected in step ST6 according to a comparison condition set by users and read from a condition storage unit 14 and then returns to step ST8 in which a communication switching unit 18 switches from a current communication unit to the communication unit selected in step ST13 and then, in step ST9, sends a notification of the theft of the vehicle and latest information about the current position of the vehicle determined by the vehicle position determination unit 11 to the management center side equipment 6 by way of the communication network 8 by using the selected communication unit. The on-board equipment 1 repeats above steps ST8, ST9, ST12, and ST13 until the selected communication unit succeeds in establishing connection with the management center side equipment.

As mentioned above, in accordance with this embodiment 2, the on-board equipment repeatedly selects a communication unit that is second to the one previously selected according to a comparison condition until the selected communication unit succeeds in establishing connection with the management center side equipment. As a result, the on-board equipment can surely establish connection with the management center side equipment.

Many widely different embodiments of the present invention may be constructed without departing from the spirit and scope of the present invention. It should be understood that the present invention is not limited to the specific embodiments described in the specification, except as defined in the appended claims.

What is claimed is:

1. A moving object tracking system in which on-board equipment and equipment disposed in a management center are connected to each other by way of a communication network, and said equipment disposed in the management center receives current position information on a current position of a moving object from the on-board equipment and keeps track of the moving object, said on-board equipment comprising:
a plurality of communication means for communicating with said equipment disposed in the management center in different manners; and
a communication switching means for selecting an optimum communication means from among said plurality of communication means based on the current position information when detecting a theft of said moving object.

2. The moving object tracking system according to claim 1, wherein said on-board equipment includes a theft detection means for detecting a theft of said moving object and then producing a theft detection signal indicating the theft of said moving object, a moving object position determination means for determining the current position of said moving object, an information storage means for storing a plurality of pieces of information about said plurality of communication means, which are input thereto in advance and are used to select one communication means from among said plurality of communication means, a comparison condition storing means for storing a comparison condition according to which a plurality of pieces of information read from said information storage means are compared with one another, and a comparison means for comparing the plurality of pieces of information read from said information storage means according to the comparison condition read from said comparison condition storing means when receiving the theft detection signal delivered from said moving object theft detection means, and wherein said communication switching means selects an optimum communication means from among said plurality of communication means based on a comparison result from said comparison means.

3. The moving object tracking system according to claim 2, wherein said moving object position determination means determines the current position of said moving object based on signals received by way of a GPS receiving antenna.

4. The moving object tracking system according to claim 1, wherein when said selected communication means fails to establish connection with said equipment disposed in the management center, said on-board equipment selects another communication means from among said plurality of communication means again.

5. The moving object tracking system according to claim 1, wherein said equipment disposed in the management center has a plurality of communication means that can communicate with a plurality of pieces of on-board equipment each having a plurality of communication means for communicating with said equipment disposed in the management center in different manners.
